(19) United States
(12) Patent Application Publication
(10) Pub. No.: US 2007/0057645 A1
(43) Pub. Date: Mar. 15, 2007

(54) Hyper-drive button for D.C. motor powered vehicle

(75) Inventor: Greg Alan Bengeult, Auburn, WA (US)

Correspondence Address: ANTHONY CLAIBORNE, 849 136TH AVE. N.E., BELLEVUE, WA, 98005, US

(73) Assignee: Evader, Inc.

(21) Appl. No.: 11/224,423

(22) Filed: Sep. 12, 2005

(51) Int. Cl. H02P 7/00

(52) U.S. Cl. 318/434

(57) ABSTRACT

A controller coupled with a user interface together enable a user temporarily to elevate the power curve of motor operation in electric vehicles that utilize pulse width modulation controllers to regulate mechanical power supplied by commutator type direct current motors. The user interface comprises a switch which, in its normal state, allows the controller to operate the motor along a standard power curve that may be optimized to conserve electrical charge. When the user sets the switch out of its normal state, the controller elevates the current limit applied to vehicle operation, thereby enabling the motor to operate along an elevated power curve, permitting enhanced vehicle performance. In preferred embodiments, the user interface is fashioned so that standard operation is the preferred, default mode of operation of the vehicle and enhanced operation will be selected only temporarily and as needed.

### BACKGROUND OF THE INVENTION

1. Field of the Invention

This invention relates to manual control of the speed of electrically powered vehicles. More particularly, this invention relates to an improvement in the user interface and control of vehicles having direct current motors with commutators, whose speed is controlled by pulse width modulated direct current, the improvement permitting the user temporary to elevate the power curve of the motor.

2. Description of the Related Art

To vary the speed of a direct current motor with commutators, modern systems typically employ pulse width modulation. In control by pulse width modulation, a circuit between a direct current source and a direct current drain is pulsed by opening and closing at a specific frequency, controlling the variable of interest by varying the duration or width of the pulse. In the case of controllers for direct current motors with commutators, the width of the pulse at a given frequency is directly related to motor speed. The voltage across the motor is always either in a full “on” condition or a full “off” condition, with the ratio of “on” duration to “off” duration determining average motor current and, hence, motor speed. For a given supply of current, power to the motor approaches that at dead short as the duration of the pulse or “on” condition grows broader, while power to the motor is reduced by shortening the duration of the pulse and is cut off altogether when the pulse duration is reduced to zero. In comparison with other means of varying direct current motor speed, such as resistive circuitry, pulse width modulation is a highly efficient means of control because it uses effectively all of the available current from the current source for driving the motor.

Embodiments of pulse width controllers for direct current motors typically use solid state devices for providing motor drive current at variable pulse width. In such controllers, typically a network comprising a plurality of solid state devices deployed in parallel is used to accommodate the relatively large amounts of current involved in driving the motor. Modern controllers commonly employ power MOSFET (metal oxide semiconductor field effect transistor) or IGBT (insulated gate bipolar transistor) network for such purpose.

A controller employing such a network is described in U.S. Pat. No. 4,626,750 issued to Post. Post employs a power MOSFET network as a high-speed switch to deliver power to a motor using a periodic on/off cycle generated in response to an operator input. Post's user interface comprises a throttle control allowing user input to a variable resistance to generate a signal representative of desired vehicle speed. Post's controller then compares that signal to a reference signal in order to determine the on/off cycle of conduction for the power MOSFET network. For example, at full speed, the power MOSFETS will conduct 100% of the time while at half speed, the power MOSFETS will conduct at approximately a 50% duty cycle.

Throttle operation for user regulation of motor speed in a D.C. motor powered electric vehicle is usually fashioned to be familiar to drivers accustomed to operating internal combustion engine powered vehicles: the power applied to the motor is proportional to displacement of the throttle control from its lowest power setting. So, for example, with a floorboard based throttle as in an automobile, power applied to the motor is proportional to the depression of the throttle in response to pressure from the operator's foot, while, with a handlebar grip based throttle as in a motor scooter or motorcycle, more power is applied to the motor as the operator rotates the grip. In any case, displacement of the throttle control from the lower power setting to higher power setting causes the motor to operate at a higher power level along its power curve.

Optimal tuning of a vehicle powered by an electric motor will balance the need for power against the need to conserve available charge, in order simultaneously to maximize performance, driving range and time before recharging is needed. Accordingly, the power curve for an electrically powered vehicle will generally be fixed to optimize these values. As known to those of skill in the art, the power curve for pulse width modulated inductive direct current motors is generally regulated by limiting the provision of current to the motor over time. Current limiting circuitry regulates the amount of current consumed by the vehicle over time to constrain vehicle performance within established standard performance parameters, which may be tuned to restrict vehicle performance within an optimized power curve.

At times, however, a need arises to elevate the vehicle's power curve temporarily above the constraints of the standard performance parameters, for example when passing other vehicles. At such times, the availability of extra power would greatly enhance the utility of the vehicle, while, if the duration of power elevation is short and only as needed, available charge will not be unduly diminished.

What is needed is control for a vehicle powered by an electric motor that, in response to a signal from the user, overrides current limiting circuitry, thereby allowing enhanced vehicle performance along an elevated power curve. What is needed further is a user interface whereby it is natural for the user normally to operate the vehicle within its standard power curve, elevating the vehicle's power curve only temporarily and as needed, so that available charge is conserved.

### BRIEF DESCRIPTION OF THE INVENTION

The present invention is a controller coupled with a user interface that together enable a user temporarily to elevate the power curve of motor operation in electric vehicles that utilize pulse width modulation controllers to regulate mechanical power supplied by commutator type direct current motors. The user interface comprises a switch which, in its normal state, allows the controller to operate the motor along a standard power curve that may be optimized to conserve electrical charge. When the user sets the switch out of its normal state, the controller elevates the current limit applied to vehicle operation, thereby enabling the motor to operate along an elevated power curve, permitting enhanced vehicle performance. In preferred embodiments, the user interface is fashioned so that standard operation is the preferred, default mode of operation of the vehicle and enhanced operation will be selected only temporarily and as needed.

### BRIEF DESCRIPTION OF THE DRAWINGS

Other objects, advantages, features and characteristics of the present invention, as well as methods, operation and function of related elements of structure, and the combination of parts and economies of deployment, will become apparent upon consideration of the following description and claims with reference to the accompanying drawings, all of which form a part of this specification, wherein:

FIG. 1 is a graph depicting pulse width modulation to vary power supplied to the motor according to the present invention;

FIG. 2 is a graph depicting power supplied to the motor when circuitry limiting current to the standard power curve is engaged according to the present invention;

FIG. 3 is a graph showing power supplied to the motor when current is limited to provide a standard power curve in contrast with power supplied when the current limit is elevated to provide an enhanced power curve;

FIG. 4 is an illustration of placement of the throttle and the Hyper-Drive button on the vehicle's handlebars in an embodiment of the present invention; and

FIG. 5 is a circuit diagram for current limiting circuitry enabling enhanced power in an embodiment of a controller according to the present invention.

### DETAILED DESCRIPTION OF THE PREFERRED EMBODIMENTS

As described above, pulse width modulation control of electric motor speed is accomplished by varying the width of pulses of voltage that are supplied to the electric motor over time. When the pulse duration is short, a smaller amount of current is supplied to the motor over time, while increasing the duration of pulses supplies more current to the motor, thereby increasing the power supplied by the motor.

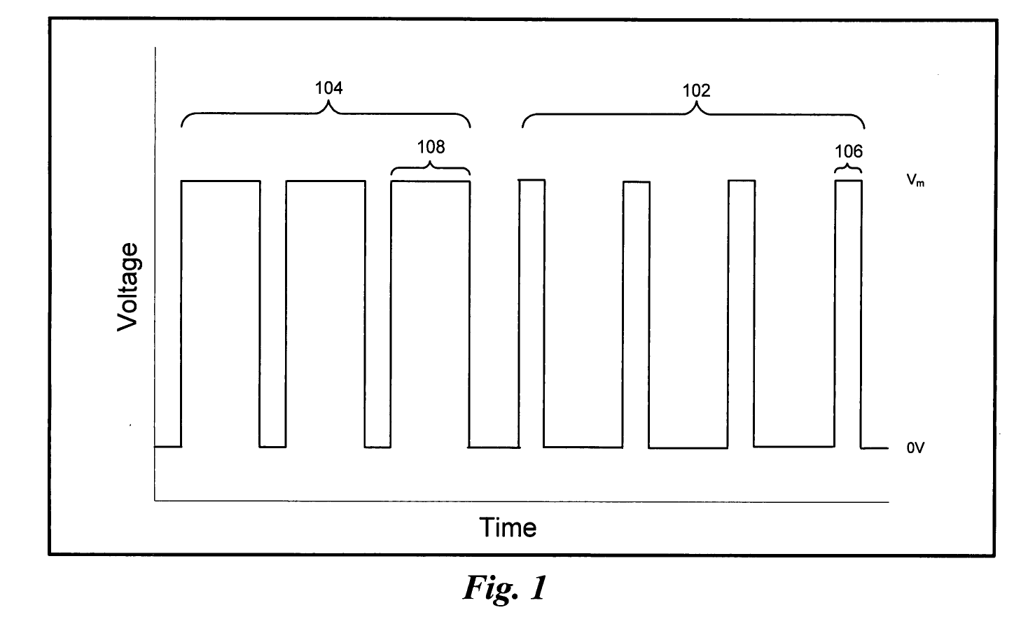

FIG. 1 is a graph depicting idealized pulse width control of motor power over time.

As understood by persons of skill in the art, actual pulse width modulation controllers do not provide perfect square wave pulses. However, it also will be recognized that the depiction of such pulses as perfect square waves herein is sufficient to illustrate principles of operation so that persons of skill in the art may make and use the present invention.

Turning to FIG. 1, along interval 102 voltage is in the full “on” condition less than half the time, as indicated by the width 106 of the narrower pulses in interval 102, while along interval 104, perhaps responsive to increased displacement of the throttle by the user, voltage is in the full “on” condition more than half the time, as indicated by the width 108 of the broader pulses in interval 104. Because more current is delivered to the motor in interval 104 than in interval 102, the motor will deliver more power in interval 104. By modulating the width of pulses of voltage supplied to the motor over time, the controller enables the user to control the power supplied by the electric motor and thereby to control speed and acceleration of the vehicle under motor power.

As discussed earlier, limiting current in general serves to keep the performance of the vehicle within a power curve that conserves available charge, enabling tuning the performance of the vehicle to an optimized power curve. However, it is desirable to limit the current supplied to induction motors over time in a number of other circumstances. As understood by persons of skill in the art, when the armature of a direct current motor is at rest it has very little resistance, and so if normal working voltage is applied, a large quantity of current can flow which may damage the commutator or armature windings. Current limiting functionality can prevent such excessive surges in current which could harm the motor and control circuitry. Heat generated by handling large quantities of current by the controller power transistors or by the motor can, if unchecked, result in damage to the controller or to the motor itself. Current limiting circuitry can be engaged when abnormally high temperatures are detected in the controller or motor, thereby preventing component damage. When available charge has become very low, operation of the motor at higher levels of current will result loss of all available charge in short order. Current limiting circuitry can be engaged when it is determined that available charge is low, in order to maximize remaining operating time or cruising range. For these and other reasons, pulse width modulated direct motor controllers generally have some form of current limiting circuitry that is called into play when conditions merit limiting current supplied to the motor over time.

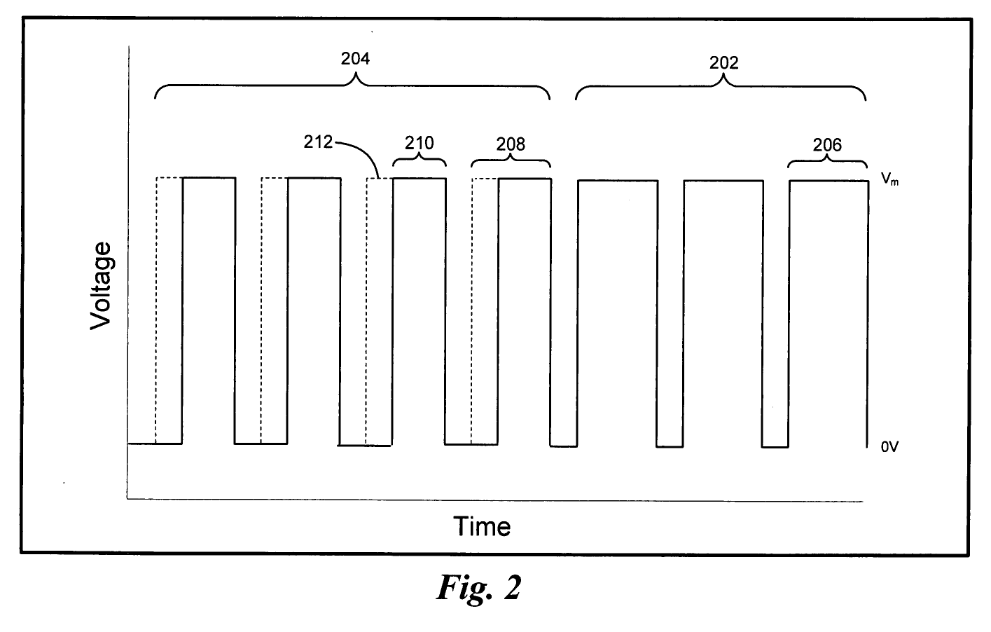

Turning now to FIG. 2, depicted is a graph illustrating an embodiment of pulse width control in which current is limited. In interval 202, the current usage is within the current limit set in the controller, and so no current limiting action has been taken. In interval 204, however, a current limit has been reached. Even though, as depicted, the user has not changed the throttle setting, in interval 204 the normal width 208 of pulses is clipped, resulting in pulses of narrower width 210. As depicted for this embodiment, pulse 208 is clipped by cutting voltage at the trailing edge 212 of pulses in interval 204. The result of clipping pulses in interval 204 is that the current delivered to the motor over time in interval 204 by pulses of narrower width 210 is limited below the current that would be delivered over time by pulses of broader width 206, 208.

While clipping pulses at the trailing edge is a commonplace practice for limiting current in pulse modulated controllers, persons of skill in the art understand that current limitation may be effected in manners not depicted herein, such as by clipping leading pulse edges or by simply eliminating certain sets of pulses in the pulse width modulation waveform altogether. The principles of the present invention apply to all such means and are not limited to any particular embodiment of current limiting functionality in pulse width modulated controllers.

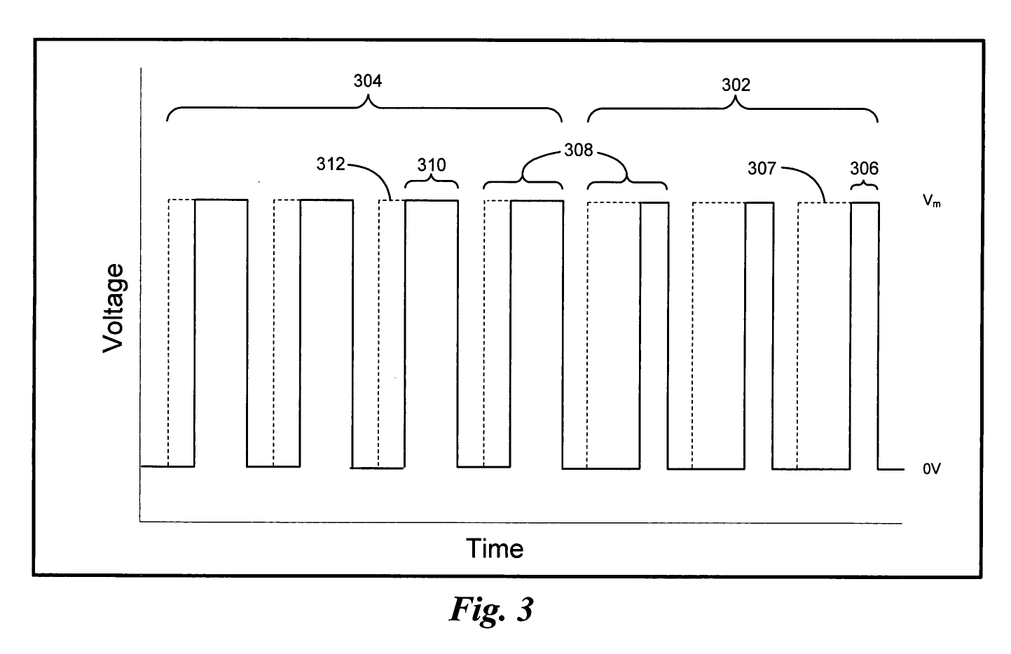

FIG. 3 contrasts a standard current limit with an elevated current limit resulting from user selection of enhanced mode operation according to the present invention. In interval 302, current limitation is in effect. As previously discussed in reference to FIG. 2, current limitation in interval 302 entails clipping the trailing edge 307 of the modulated pulse 308, resulting in a narrowed pulse width 306 that delivers limited current over time. In interval 304, enhanced mode operation has been selected. The result is that a higher current limit is set in interval 304 than was set in interval 302. Within enhanced mode interval 304, the portion 312 of waveform 308 that is clipped for current limitation is less than the portion 307 of waveform 308 that is clipped in standard mode interval 302. Accordingly, pulses 310 in interval 304 are wider than pulses 306 in interval 302, and thereby more current is delivered over time in interval 304 than in interval 302, resulting in enhanced performance of the motor and the vehicle.

As will be understood by those of skill in the art, means of providing an enhanced current limit to the motor, other than that depicted in FIG. 3, are possible in keeping with the teachings of the present invention. For example, standard mode current limitation may clip both leading and trailing pulse edges, while enhanced mode current limitation may clip only one of the leading or trailing pulse edges. In other embodiments, current limitation in standard mode may entail eliminating a certain regularly occurring set of pulses in the waveform altogether, while enhanced mode operation may eliminate only a subset of such pulses. As will be clear to those of skill in the art, these and other means of applying a plurality of current limits to pulse width modulated direct current motor control are within the scope of the present invention.

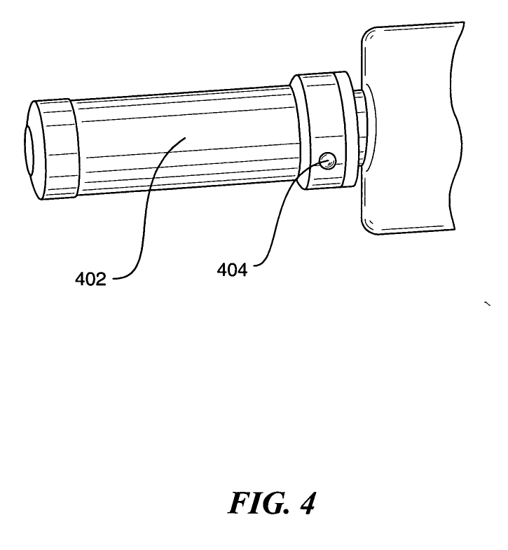

Turning now to FIG. 4, depicted is the placement of the hyper-drive switch in relation to the vehicle handgrip in an embodiment of the present invention. As depicted, handgrip 402 is a conventional motor scooter handgrip familiar to those of skill in the art. Hyper-drive switch 404 is a switch, placed to be convenient to the user's thumb, which, when actuated, switches the vehicle's performance curve from the standard power curve to the enhanced power curve. Preferably, switch 404 is a momentary switch requiring pressure to activate, whereby the vehicle operates along its standard power curve unless the user is actually depressing switch 404 to engage enhanced mode operation. Fashioning the user interface in this manner enables easy user selection of elevated power when it is needed while encouraging the normal operation of the vehicle along its standard power curve, whereby the dissipation of remaining available charge resulting from operation in the enhanced mode occurs only when the user has determined that power elevation is actually needed.

As generally implemented in MOSFET based pulse width modulating direct current motor controllers, the current delivered at peak voltage is limited by circuitry which thereby determines the applicable power curve. As understood by those of skill in the art, and as exemplified in embodiments depicted in Post supra, current usage in such systems is regulated by comparing voltage drop between power MOSFET drain and source electrodes, indicative of MOSFET current flow when the power MOSFETs are conducting, with a reference voltage corresponding to a desired current limit.

Comparator circuitry then limits the duty cycle of the power MOSFETs so that MOSFET current flow, as indicated by drain-source voltage, does not exceed the current limit indicated by the reference voltage.

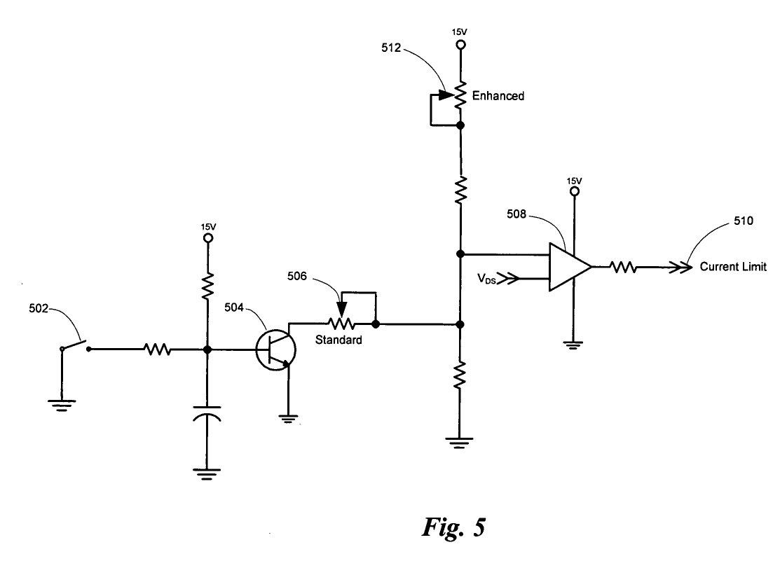

Turning to FIG. 5, illustrated is circuitry for an embodiment of the present invention that selectively provides one of two reference voltages, one such voltage being a reference for the current limit for standard operation, the other such voltage being a reference for the current limit for enhanced operation.

In the depicted embodiment, hyper-drive switch 502 is a normally open SPST type switch, in communication with the base of transistor 504. In normal operation with switch 502 open, the base of transistor 504 is supplied with voltage and therefore transistor 504 normally conducts current through standard mode variable resistor 506, thereby supplying normal voltage to comparator 508. Comparator 508 in general supplies reference voltage 510 to circuitry limiting current supplied to the MOSFET power transistors, as described above. In normal mode, the reference voltage signal 510 supplied by comparator 508 is based on voltage supplied by transistor 504 through standard mode variable resistor 506. Variable resistor 506 is tuned so that the reference voltage 510 supplied by comparator 508 normally corresponds to the current limit required for standard mode operation, which in preferred embodiments in turn corresponds to providing an optimized power curve for system performance.

When hyper-drive switch 502 is closed, base voltage to transistor 504 is grounded, thereby switching off voltage supplied by transistor 504 through standard mode variable resistor 506 to comparator 508. In such case, voltage supplied to comparator 508 instead derives from enhanced mode variable resistor 512. Variable resistor 512 is tuned so that the reference voltage 510, supplied by comparator 508 when hyper-drive switch 502 is closed, corresponds to the elevated current limit employed in the enhanced mode of system operation, corresponding in turn to a power curve wherein system performance is elevated. In the depicted embodiment, because switch 502 is normally open, the enhanced mode of operation will occur only when the user depresses the switch. The default, normal operation of the system will be in standard mode.

As will be appreciated by those of skill in the art, embodiments of the present invention differing from that depicted in FIG. 5 may be constructed which accomplish the same end of supplying one of two distinct reference voltage signals based upon user selection of operating mode. For example, switch 502 may simply be an SPDT type switch that switches electromechanically between two reference voltages supplied to the current limiting circuitry, one such voltage corresponding to standard mode operation and the other such voltage corresponding to enhanced mode operation. It is to be understood that the present invention encompasses all such embodiments. What is needed is simply that the invention supply one of two reference voltages, one of which is normally supplied and corresponds to standard mode operation, and the other of which is supplied only when selected by the user and corresponds to enhanced mode operation.

As will be further appreciated by those of skill in the art, the present invention as described does not exclude the limitation of current supplied to the power MOSFETs for reasons other than user selection of operation mode. For example, as discussed above, it is desirable to limit current when the motor is started because of the low resistance of the armature and the risk of motor damage from current surge. By way of further example, for purposes of safety and system protection, it may be desirable to limit MOSFET current based on measurements of the operating temperature of system components, such as controller circuitry or the motor itself. Yet further, it may be desirable to limit MOSFET current based upon a determination of low voltage in the system power supply in order to conserve available charge, effectively changing the power curve to favor such conservation. As will be appreciated by those of skill in the art, embodiments of the present invention do not prevent these and other additional controls limiting MOSFET current. As will be further appreciated, embodiments may be constructed wherein some such other controls (such as those directed toward safety and system protection) override the user's selection of enhanced mode operation. Rather than excluding such controls, the present invention is complementary to such additional controls, enabling embodiments accommodating the user's need for temporarily enhanced performance when appropriate.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. It is intended that the scope of the present invention encompass all means known to those of skill in the electronics arts to provide a temporarily enhanced power curve for vehicles employing pulse code modulated commutator motor controllers as generally described in the foregoing.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

What is claimed is:

1. (canceled)

2. (canceled)

3. (canceled)

4. (canceled)

5. (canceled)

6. (canceled)

7. (canceled)

8. (canceled)

9. An apparatus for controlling the speed of a vehicle powered by a direct current motor, comprising a pulse width modulated motor speed regulator supplying current to the motor, the regulator comprising a means for limiting current supplied to the motor to a given current limit, the current limiting means normally limiting current to a standard current limit, the current limiting means further, responsive to signal from the user, limiting current to an elevated current limit.

10. An apparatus according to claim 9, wherein the means for limiting current supplied to the motor comprises a comparator that compares voltage corresponding to pulse current supplied to the motor with a reference voltage corresponding to the given current limit.

11. An apparatus according to claim 9, wherein the standard current limit is set for optimal vehicle performance along an optimized power curve.

12. An apparatus according to claim 9, wherein the elevated current limit is set for enhanced vehicle performance along an elevated power curve.

13. An apparatus with user interface for controlling the speed of a vehicle powered by a direct current motor, comprising a pulse width modulated motor speed regulator supplying current to the motor, the regulator comprising current limiting circuitry limiting the current provided to the motor, the current limiting circuitry normally providing a first current limit for motor operation at a standard current level, the circuitry further, responsive to user selection of enhanced mode, providing a second current limit for motor operation at an elevated current level.

14. An apparatus according to claim 13, wherein the user interface comprises a button which selects enhanced mode operation when held in the depressed position.

15. An apparatus according to claim 13, wherein the current limiting circuitry employs a reference voltage signal to limit the current provided to the motor.

16. An apparatus according to claim 13, wherein the first current limit is adjustable for optimal vehicle performance along an optimized power curve.

17. An apparatus according to claim 13, wherein the second current limit is adjustable for enhanced vehicle performance along an elevated power curve.

18. An apparatus for controlling the speed of a vehicle powered by a direct current motor, comprising a pulse width modulated motor speed regulator supplying pulse current to the motor, the regulator comprising a comparator that compares voltage corresponding to pulse current supplied to the motor with a reference voltage corresponding to a given current limit, the reference voltage normally set to a first level corresponding to a current limit for motor operation along an optimized power curve, the apparatus further comprising a switch, the operation of said switch setting the reference voltage to a second level corresponding to a current limit for motor operation along an elevated power curve.
